(19) United States
(12) Patent Application Publication
(10) Pub. No.: US 2001/0054054 A1
(43) Pub. Date: Dec. 20, 2001

(54) Apparatus and method for controllably retrieving and/or filtering content from the world wide web with a profile based search engine

(76) Inventor: Steven Robert Olson, Portland, OR (US)

Correspondence Address: Steven Robert Olson, 720 N.W. Westover Circle, Portland, OR, 97210, US

(21) Appl. No.: 09/768,056

(22) Filed: Jan. 24, 2001

Related U.S. Application Data
(60) Provisional application No. 60/192,188, filed on Mar. 27, 2000.

(51) Int. Cl. G06F 7/00

(52) U.S. Cl. 709/1; 707/1

(57) ABSTRACT

A method of controllably retrieving information from the World Wide Web or from a given database in cooperation with a user's composite profile, comprising the steps of: (a) prompting a user to respond to at least one profile query; (b) generating a composite user profile from response(s) to said at least one query; (c) generating at least one portal having one or more records of information from a central repository; (d) matching said composite user profile with said at least one portal; (e) entering at least one search or retrieval instruction; and (f) controllably retrieving one or more records of information from said at least one matched portal in response to said at least one search instruction.

### CROSS-REFERENCE TO RELATED APPLICATION(S)

This application claims the benefit of U.S. Provisional Application No. 60/192188, filed Mar. 27, 2000.

### BACKGROUND OF THE INVENTION

1. Field of the Invention

The present invention relates to electronic commerce and informational search methods, and more particularly, to electronic commerce and informational search methods which utilize profile based filters and/or search engines to accurately, precisely, and efficiently match a user's volitionally and/or non-volitionally obtained profile to subject matter and content available on the Internet or a designated database.

2. Background Art

Conducting business transactions online for goods, services, and/or information has been the known in the art for years. Furthermore, directing users to particular content on the Internet or a designated database is likewise well known. Specifically, many web sites designed for “homepage” applications have “keyword” search engines which direct users, albeit in an extremely limited and primitive manner, to particular content on the Internet. While these “keyword” search engines have become common, their inability to accurately, precisely, and efficiently match content on the Internet with a user's product service, and/or informational desires remains largely problematic. Simply put, obtaining a desired product, service, and/or information using a conventional “keyword” search engine can be a frustrating and inefficient business experience. This is especially true inasmuch as conventional “keyword” search engines are not readily capable of conducting precise and effective searches when one or more specific, independently valued variables are inputted independently or simultaneously—which is a common requisite for carrying out an informational search or business transaction online.

It is therefore an object of the present invention to provide users with profile based filters and/or search engines that are capable of efficiently matching users product, service, and/or informational desires with content on the internet, and to in turn, remedy the aforementioned detriments and/or complications associated with conventional electronic commerce shopping and/or informational retrieval methods.

These and other objects of the present invention will become apparent in light of the present Specification, claims, and Drawings.

### SUMMARY OF THE INVENTION

The present invention is directed to a method of controllably retrieving information from a database or content available on the Internet, in cooperation with user's specific and/or composite profile comprising of the steps of: (a) prompting a user to respond to at least one profile query; (b) generating a composite user profile from response(s) to at least one query; (c) generating at least one portal having one or more records of information from a central repository; (d) matching the composite user profile with at least one portal; (e) entering at least one search instruction; and (f) controllably retrieving one or more records of information from at least one matched portal in response to the at least one search instruction.

In a preferred embodiment of the invention, the step of prompting a user(s) response to at least one profile query includes the step of prompting a user(s) for profile information selected from the group consisting essentially of psychological profile, a physical profile, a lifestyle profile, and interest profile, and entertainment preference profile, an astrological profile, a demographical profile, a financial profile, a preferred method of payment profile, a taste profile, a personality type profile, and combinations, in whole or in part, thereof. In this embodiment the step of prompting is preferably executed in an overt manner.

In another preferred embodiment of the present invention, the step of prompting a user(s) response to at least one profile query includes the step of prompting a user to respond specifically to psychological, physical, demographical and financial profile data.

In yet another preferred embodiment of the present invention, the step of requesting or determining a user(s) response to at least one profile query include the step of prompting a user(s) for the same either on-line or off line.

Preferably, the step of generating a specific and/or composite user profile from responses to the at least one query includes the steps of assigning a weight factor to one or more query responses.

In accordance with the present invention, the step of generating at least one portal having one or more records of information from a central repository may further include the step of singularly or multiply bifurcating the at least one portal of records.

In a preferred embodiment of the present invention, the step of generating at least one portal having one or more records of information from a central repository includes the step of generating at least one portal having one or more records of information from the world wide web.

Additionaly, the step of matching the specific or composite user(s) profile with the at least one electronic environment or portal may include the step of assigning a weight factor to the at least one portal(s).

In another preferred embodiment of the present invention, the step of controlably retrieving or filtering one or more records of information from at least one matched portal in response to the at least one search instruction includes the step of eliminating certain records of information which do not comport with the specific or composite user profile.

Preferably, the above-identified method further comprises the step of purchasing at least one of a good, a service, and information from the one or more retrieved records of information.

The present invention is also directed to a method of controllably retrieving information from the world wide web or a database in cooperation with a user(s) specific or composite profile comprising the steps of: (a) prompting a user to respond to at least one profile query wherein the at least one profile query is directed to the group consisting essentially of a psychological profile, a physical profile, an astrological profile, a demographic profile, a financial profile, a preferred method of payment profile, a taste profile, a personality profile, other personal characteristics that could be use to determine a user(s) preferences, and combinations, in whole or in part, thereof; (b) generating a composite user profile from response(s) to at least one query, wherein the responses to that one or more queries is assigned a weight factor; (c ) generating at least one portal having one or more records of information from a central repository, wherein the central repository is the world wide web; (d) matching the composite user profile with the at least one portal; (e) entering at least one search instruction; and (f) controllably retrieving one or more records of information from the at least one matched portal in response to the at least one search instruction.

The present invention is also directed to a method of controllably retrieving information from a database in cooperation with a user's composite profile comprising the steps of: (a) prompting the user to respond to at least one profile query; (b) generating a composite user profile from response(s) to the at least one query; (c ) matching the composite user profile with at least one filtered portal of a central repository; (d) entering at least one search instruction; and (e) controllably retrieving one or more records from the at least one matched portal in response to the at least one search instruction.

In accordance with the present invention an apparatus for controllably retrieving information from a database in cooperation with a user's composite profile is provided, which comprises (a) means for prompting a user to respond to at least one profile query; (b) a processor for generating a composite user profile from response(s) to the at least one query; (c ) means for accessing the at least one portal having one or more records of information from a central repository; (d) a processor for matching the composite user profile with the at least one portal; (e) means for entering at least one search instruction; and (f) means for controllably retrieving one or more records of information from the at least one matched portal in response to the at least one search instruction.

### BRIEF DESCRIPTION OF THE DRAWINGS

The invention will now be described with reference to the drawings wherein:

FIG. 1 of the drawings is a schematic representation of a prior art direct address user method;

FIG. 2 of the drawings is a schematic representation of a prior art keyword search engine address user method; and

FIG. 3 of the drawings is a schematic representation of a profile based search engine user method in accordance with the present invention.

### DETAILED DESCRIPTION OF THE INVENTION

While this invention is susceptible of embodiment in many different forms, there is shown in the drawings and described herein in detail several special embodiments with the understanding that the present disclosure is to be considered as an exemplification of the principles of the invention and is not intended to limit the invention to the embodiments illustrated.

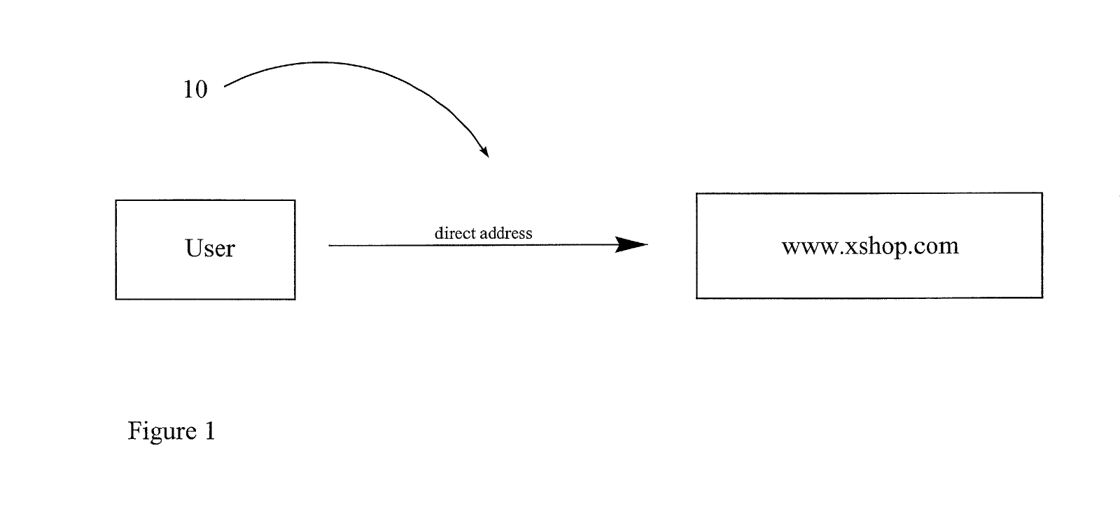

Referring now to the drawings and to FIG. 1 in particular, a prior art schematic representation of a conventional user experience 10 is shown, which generally comprises a user directly contacting a particular known site on the Internet. This method is conventionally known as the “direct address” method. Under this method, a user directly inputs the precise Internet address (e.g. www.xshop.com) to contact the desired site. Once at the site, the user can purchase a desired good, service, and/or information.

While the “direct address” method can result in a positive user experience, it does have several material drawbacks. First, the user must, via any one of a number of mechanisms, take the time to obtain the address for the particular site. The user must also evaluate whether or not the site offers particular desired qualities, such as, for example, competitive pricing, prompt shipping, reasonable customer service for damaged or returned goods-just to name a few. Furthermore, if the particular good is not currently in stock, the user has two viable options: (1) The user can place the order and wait until to particular good is in stock, or (2) The user can attempt to find an alternative site to contact directly-however, this option requires that the user either comprise additional knowledge of a particular secondary site, or that the user engage a mechanism to uncover a secondary, or sometimes a tertiary site,

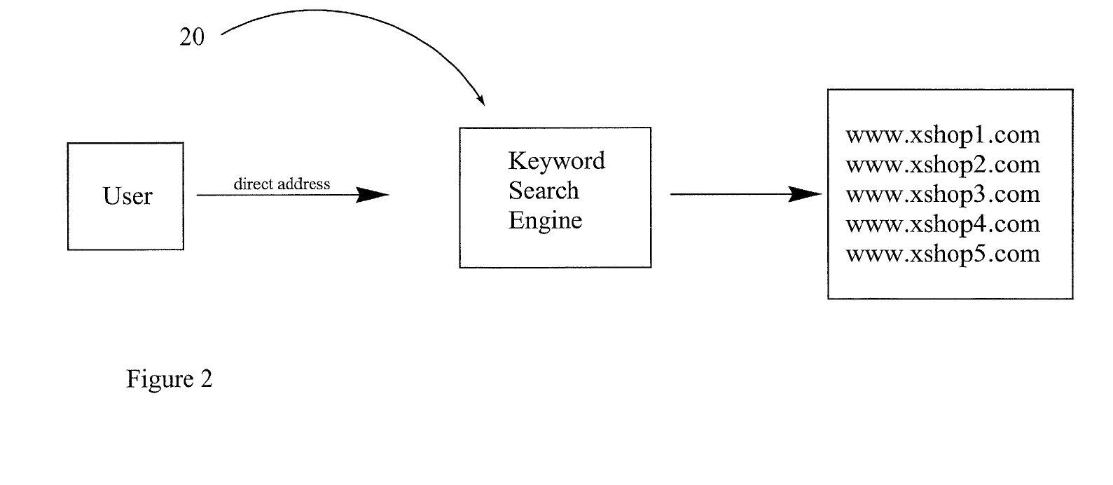

FIG. 2 shows a schematic representation of a second, prior art user experience 20, which generally comprises a user contacting a common internet search engine. Such conventional search engines can be found at, for example, www.yahoo.com, www.excite.com, www.altavista.com., and www.aol.com. This method is conventionally known as the “keyword search engine address” method. Under the keyword search engine address method, a user first contacts, for example, an above-identified web site and inputs key words, which are applicable to the user's desire. For example, if a user is interested in purchasing a pair of hiking boots, the user is required to input applicable keywords such as, hiking boots, hiking apparel, or mountain gear, etc. The user then commands that a search be executed based upon the above-identified keywords. Upon execution of the search, the search engine, uncovers several “hits” or applicable internet addresses (e.g. www.xshopl.com., www.xshop2.com., www.xshop3.com., www.xshop4.com., www.xshop5.com.,)—the manner in which these addresses are uncovered varies dramatically from site to site, thereby rendering the process highly inconsistent and unpredictable for even simple shopping tasks. Moreover, it does not consider the distinct personality or profile(s) of the user.

Once a user has uncovered several sites, he/she must visit each site to determine its genuine applicability to the particular goods, services, and/or information sought after by the user, wherein the user can experience the same above-identified detriments and/or complications associated with using the “direct address” method.

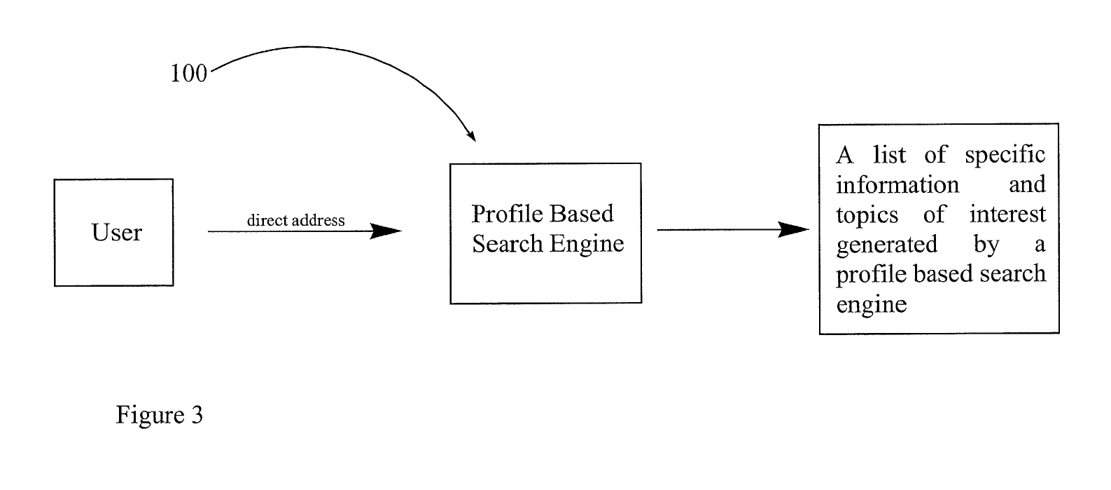

The present invention remedies the above-identified complications and/or detriments by incorporating a novel “profile based search engine” or a “profile based content filter” into a users online experience. FIG. 3, shows a schematic representation of a user's experience 100, which generally comprises a user contacting an internet site using a “profile based search engine” or “profile based content filter” The profile based search engine or profile based content filter, upon an initial contact, prompts, requests or determines a user(s) response to at least one profile question; the user for answers to questions (i.e. multiple input variables), which in turn, facilitates the development of various profiles, lifestyle profile, income profiles, net worth profiles, physical profiles, astrological profiles, interest profiles, demographic profiles, etc. Depending upon the particular application, the user can be prompted for information ranging from a limited personal profile for a single, specific need to a complete personal profile for comprehensive shopping, interests, and informational needs.

Once a user profile has been developed, the search engine and/or a profile based content filter can intelligently match predetermined internet sites which are genuinely applicable to the user's profile-toward efficiently completing, for example, online shopping experiences. Using this method, undesired and/or irrelevant internet sites can be avoided, thereby enhancing the online experience.

Although not necessary, a profile based search engine can also filter sites that are not certified by a desired agency. For example, a user may specify within any one of a number of profile queries that only internet sites selling authentic merchandise are uncovered.

In addition, a profile based search engine and/or a profile in accordance with the present invention can assign “weight” factors to various profile elements to determine which sites are uncovered. For example, if a user's psychological profile reveals that environmentally friendly products are strongly preferred, then sites identified as associated with environmentally friendly goods and/or services will be assigned a greater weight factor than, perhaps, for example, sites identified as selling goods and/or services at competitive prices. If the psychological profile indicates that an element, such as environmental compatibility is so strong, then the weight factor can eliminate altogether any sites without such a compatibility indicator.

It will be understood that the references to databases in this claim may either exist as private servers without links to the Internet or to the World Wide Web. Conversely, it also understood that the references in this claim to Databases shall not only represent autonomous data centers but shall also include content available from the Internet or the World Wide Web.

It will be understood that while disclosure is replete with reference to the Internet or World Wide Web as comprising the informational database or central repository, it is likewise contemplated that other databases or storage management entities are capable of association with a profile based search engine or a profile based portal.

It will be understood that prompting or querring the user(s) for information will also mean requesting information. It will be further understood that prompting or querring the user(s) for information will also include determining a user's response to a profile question, if the response can be determined or acquired from other independent sources of information.

The term database as it is used in this document shall include portals and electronic environments. Electronic environments shall be taken to mean a group of linked portals associated with a common culture or personality type.

It will be further understood that any one of a number of user interfaces are contemplated for use in accordance with the present invention, such as, but by no means limited to, personal computers, personal digital assistants, network computers, and/or integral processing units.

The present invention is preferably directed to a method of controllably retrieving and/or receiving information from a database or the World Wide Web in cooperation with a user's composite profile comprising a plurality of steps. Such a method may first comprise requesting or determining a user's response to at least one profile query. As previously explained, the said query may include questions directed toward a psychological profile, a physical profile (e.g. sex, height, weight, age, shoe size), a lifestyle profile, an interst profile (e.g. hobbies, career), an entertainment preference profile (e.g. theatre, movie, music, and other show types), an astrological profile, a demographical profile, a financial profile (e.g. net worth, income, investment liquidity, etc.), a preferred method of payment profile (e.g. cash, check, credit card, debit card, C.O.D.), as taste profile (food, restaurants, automobiles etc.), a personality profile (e.g. risk taker, non-risk taker, extravert, introvert, free spirited, controlled, etc.), and combinations, in whole or part, thereof. It will be understood that answering such a query can be carried out while on-line, or, alternatively while off-line. It will be further understood that answering such questions is preferably carried out in an overt manner in an attempt to obtain to the most comprehensive, accurate, and precise user profile. While not necessary, the above-identified profiles can be weighted according to a users degree of importance and/or relevance.

Once a user answers one or more questions relative to the above identified profiles, a composite user profile can be generated. The specific or composite user profile can then be efficiently coordinated and/or matched with content on the world wide web, a database or a portal having one or more records of information from a central repository.

### DETAILED DESCRIPTION OF THE INVENTION WITH RESPECT TO PORTALS

The portals are understood to be selected fragments of a larger database (e.g. the World Wide Web, etc.), which appropriately coorelate to an associated composite user profile. It will be understood that the fragmented database or portals can be either singularly or multiply bifurcated so as to effectively generate subsets of the portals for even greater matching capabilities.

After a user is matched with an appropriate portal, the user can then enter a conventional search or retrieval instruction. The search instruction, can then be processed, and, in turn, one or more records or information can be controllably retrieved. In this manner, a user is able to filter masses of undesirable products, services, and/or information in a simple, quick, efficient manner.

For example, a user can establish a composite user profile as being affluent and interested in high performance cars. As such, only protals associated with records of information matching both profile criteria will be accessed.

By way of an additional example, a user can establish a specific or composite user profile as being low net worth, a risk-taker, and adventurous. As such, if a search instruction for vacations is requested, only sites offering affordable and adventurous vacations will be accessed. All other non-compatible information and/or sites will be filtered so that the users experience is efficient and productive. In this was the user gets to the meaningful information without spending copious quantities of time sifting through non-compatible information.

The foregoing description merely explains and illustrates the invention and the invention is not limited thereto except insofar as the appended claims are so limited, as those skilled in the art who have the disclosure before them will be able to make modifications without departing the scope of the invention.

What is claimed is:

1. A method of controllably retrieving information from the World Wide Web in cooperation with a user's composite profile, comprising the steps of:
prompting a user to respond to at least one profile query;
generating a composite user profile from response(s) to the at least one query;
generating at least one portal having one or more records of information from a central repository;
matching said composite user profile with said at least one portal;
entering at least one search instruction; and
controllably retrieving one or more records of information from said at least one matched portal in response to said at least one search instruction.

2. The method according to claim 1, wherein the step of prompting a user to respond to at least one profile query includes the step of prompting a user for profile information selected from the group consisting essentially of a psychological profile, a physical profile, an interest profile, an entertainment preference profile, an astrological profile, a demographical profile, a financial profile, a preferred method of payment profile, a taste profile, a personality profile, and combinations in whole or in part thereof.

3. A method for controllably grouping, maping and organizing records of information and matching them with the user(s) that access said information. The grouping of user(s) and records of information will be based upon a user(s) composite profile.

4. The method according to claim 2, wherein the step of prompting a user to respond to at least one profile query includes the step of overtly prompting a user to respond to the same.

5. The method according to claim 2, wherein the step of prompting a user to respond to at least one profile query includes the step of prompting a user for a psychological profile, a physical profile, a demographical profile, and a financial profile.

6. The method according to claim 1, wherein the step of prompting a user to respond to at least one profile query includes the step of prompting a user for the same either on-line or off-line.

7. The method according to claim 1, wherein the step of generating a composite user profile from responses to said at least one query includes the steps of assigning a weight factor to one or more query responses.

8. The method according to claim 1, wherein the step of generating at least one portal having one or more records of information from the a central repository further includes the step of singularly bifurcating the at least one portal of records.

9. The method according to claim 1, wherein the step of generating at least one portal having one or more records from a central repository further includes the step of multiply bifurcating the at least one portal of records.

10. The method according to claim 1, wherein the step of generating at least one portal having one or more records of information from a central repository includes the step of generating at least one portal having one or more records of information from the world wide web.

11. The method according to claim 1, wherein the step of matching said composite user profile with said at least one portal includes the step of assigning a weight factor to one or more portals.

12. The method according to claim 1, wherein the step of controllably retrieving one or more records of information from the World Wide Web in response to said at least one search instruction includes the step of filtering out records of information which do not comport with said composite user profile.

13. The method according to claim 1, further comprising the step of purchasing at least one of a good, a service, and information from said one or more retrieved records of information.

14. A method of controllably retrieving information from the World Wide Web in cooperation with a user's composite profile, comprising the steps of:
prompting a user to respond to at least one profile query, wherein said at least one profile query is directed to the group consisting essentially of a psychological profile, a lifestyle profile, and interest profile, an entertainment preference profile, an astrological profile, a demographical profile, a financial profile, a preferred method of payment profile, a taste profile, a personality profile, and mixtures thereof;
generating a composite user profile from responses(s) to said at least one query, wherein the responses to the one or more queries is assigned a weight factor;
controllably matching composite user profile with specific content available on the World Wide Web, wherein that specific content is a reflection of the said composite user profile.

15. A method of controllably retrieving information from a database in cooperation with a user's composite profile, comprising the steps of:
prompting a user to respond to at least one profile query, wherein said at least one profile query is directed to the group consisting essentially of a psychological profile, a lifestyle profile, and interest profile, an entertainment preference profile, an astrological profile, a demographical profile, a financial profile, a preferred method of payment profile, a taste profile, a personality profile, and mixtures thereof;
generating a composite user profile from response(s) to said at least one query, wherein the responses to the one or more queries is assigned a weight factor;
generating at least one portal having one or more records of information from a central repository, wherein the central repository is the world wide web;
matching said composite user profile with said at least one portal;
entering at least one search instruction; and
controllably retrieving one or more records of information from said at least one matched portal in response to said at least one search instruction.

16. A method of controllably retrieving information from a database in cooperation with a user's composite profile, comprising the steps of:
prompting a user to respond to at least one profile query;
generating a composite user profile from response(s) to said at least one query;
matching said composite user profile with at least one filtered portion of a central repository;
entering at least one search or retrieval instruction; and
controllably retrieving one or more records of information from said at least one matched portal in response to said at least one search or retrieval instruction.

17. An apparatus for controllably retrieving information from the World Wide Web in cooperation with a user's composite profile, comprising the steps of:
means for prompting a user to respond to at least one profile query;
a processor for generating a composite user profile from response(s) to said at least one query;
a processor for matching said composite user profile with content on the World Wide Web;
means for controllably retrieving one or more records of information from the world wide web in response to at least one search and retrieval instruction.

18. An apparatus for controllably retrieving information from a database in cooperation with a user's composite profile, comprising the steps of:
means for prompting a user to respond to at least one profile query;
a processor for generating a composite user profile from response(s) to said at least one query;
means for accessing at least one portal having one or more records of information from a central repository;
a processor for matching said composite user profile with said at least one portal;
means for entering at least one search instruction; and
means for controllably retrieving one or more records of information from said at least one matched portal in response to said at least one search instruction.
